(19) United States
(12) Patent Application Publication
(10) Pub. No.: US 2016/0249682 A1
(43) Pub. Date: Sep. 1, 2016

(54) ELECTRONIC VAPOR PROVISION SYSTEM

(71) Applicant: NICOVENTURES HOLDINGS LIMITED, London (GB)

(72) Inventors: David LEADLEY, London (GB); Colin DICKENS, London (GB); Yingzhuo DING, Shenzhen, Guangdong (CN)

(73) Assignee: Nicoventures Holdings Limited, London (GB)

(21) Appl. No.: 15/029,325

(22) PCT Filed: Oct. 18, 2013
(86) PCT No.: PCT/CN2013/085455

§ 371 Date: Apr. 14, 2016

(51) Int. Cl. A24F 47/00; H05B 3/00

(52) U.S. Cl. CPC A24F 47/008; H05B 3/0014

(57) ABSTRACT

An electronic vapor provision system includes a first unit comprising a battery and a second unit comprising a heater and a nicotine source for producing nicotine vapor when heated. The first unit and the second unit comprise a bayonet fitting for providing a mechanical and electrical connection therebetween. The system has a longitudinal axis, and the bayonet fitting is configured such that the first and second units are connected by relative movement thereof along the longitudinal axis to a first engagement position, and relative rotation of the first and second units about the longitudinal axis from the first engagement position to a final engagement position that prevents both (i) relative movement of the first and second units along the longitudinal axis, and (ii) relative rotation of the first and second units further away from the first engagement position.

### PRIORITY CLAIM

The present application is a National Phase entry of PCT Application No. PCT/CN2013/085455, filed Oct. 18, 2013, which is hereby fully incorporated herein by reference.

### FIELD

The present disclosure relates to electronic vapor provision systems such as electronic nicotine delivery systems, including e-cigarettes.

### BACKGROUND

Electronic vapor provision systems such as e-cigarettes generally contain a reservoir of liquid which is to be vaporized, typically nicotine. When a user inhales on the device, a heater is activated to vaporize a small amount of liquid, which is therefore inhaled by the user. Many such devices comprise multiple components which can be separated in an axial direction, for example to replace a cartridge containing a reservoir of nicotine that has now been exhausted and/or to recharge a cell or battery which is used to power the heater. The point of separation between two such components represents a potential weakness in the overall structure of an e-cigarette.

### SUMMARY

The invention is defined in the appended claims.

Some embodiments provide an electronic vapor provision system that includes a first unit comprising a battery or cell and a second unit comprising a heater and a nicotine source for producing nicotine vapor when heated. The first unit and the second unit comprise a bayonet fitting for providing a mechanical and electrical connection between the first and second unit. The electrical connection allows the battery or cell to provide power to the heater to produce nicotine vapor from the nicotine source. The electronic vapor provision system has a longitudinal axis, and the bayonet fitting is configured such that the first and second units are connected by relative movement of the first and second units along said longitudinal axis to a first engagement position, and relative rotation of the first and second units about the longitudinal axis from the first engagement position to a final engagement position that prevents both (i) relative movement of the first and second units along said longitudinal axis, and (ii) relative rotation of the first and second units further away from the first engagement position. The bayonet fitting further includes a biasing means that provides a rotational bias to prevent rotation of the first and second units from the final engagement position to the first engagement position.

Some embodiments provide an apparatus comprising a first unit for connection by a bayonet fitting to a second unit in an electronic vapor provision system having a longitudinal axis. The bayonet fitting provides a mechanical and electrical connection between the first and second units. The first unit is arranged to: receive insertion of the second unit along said longitudinal axis to a first engagement position of the bayonet fitting; and allow the second unit to rotate about the longitudinal axis from the first engagement position to a final engagement position that prevents both (i) relative movement of the first and second units along said longitudinal axis, and (ii) rotation of the second unit past the final engagement position further away from the first engagement position. The first unit further includes in the bayonet fitting a biasing means that applies a rotational bias against rotation of the second unit from the final engagement position back to the first engagement position.

Some embodiments provide an electronic vapor provision system comprising first and second parts which when connected define a longitudinal axis, wherein the first and second parts are mechanically and electrically connectable via a bayonet fitting, the bayonet fitting providing co-axial and radial mechanical bias relative to the longitudinal axis.

The approach described herein is not restricted to specific embodiments such as set out above, but includes and contemplates any appropriate combinations of features presented in the whole document. For example, an electronic vapor provision system may be provided in accordance with the approach described herein which includes any one or more of the various features described above.

### BRIEF DESCRIPTION OF THE DRAWINGS

FIG. 1 is a schematic (exploded) diagram of an e-cigarette in accordance with some embodiments of the disclosure.

FIG. 2 is a schematic diagram of the body of the e-cigarette of FIG. 1 in accordance with some embodiments of the disclosure.

FIG. 3 is a schematic diagram of the cartomizer of the e-cigarette of FIG. 1 in accordance with some embodiments of the disclosure.

FIG. 4 is a cross-section, in a plane parallel to the longitudinal axis of the e-cigarette, through the connector provided in the body of the e-cigarette of FIG. 1 in accordance with some embodiments of the disclosure.

FIG. 5 is a cross-section, in a plane perpendicular to the longitudinal axis of the e-cigarette, through the connector which joins the body and the cartomizer in the e-cigarette of FIG. 1 at one stage of engagement in accordance with some embodiments of the disclosure.

FIG. 6 is a cross-section, in a plane perpendicular to the longitudinal axis of the e-cigarette, through the connector which joins the body and the cartomizer in the e-cigarette of FIG. 1 at a further stage of engagement in accordance with some embodiments of the disclosure.

FIG. 7 is a schematic plot of two force curves showing the force exerted by a U-spring in the e-cigarette of FIG. 1 at various points of engagement in accordance with some embodiments of the disclosure.

### DETAILED DESCRIPTION

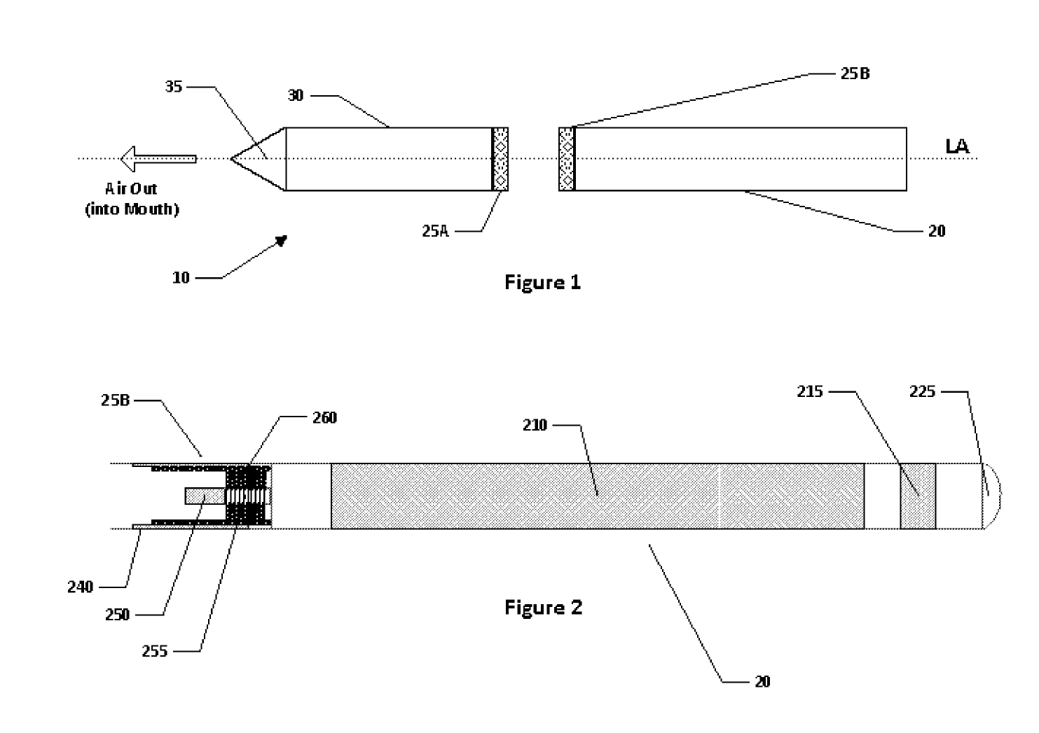

FIG. 1 is a schematic diagram of an e-cigarette 10 in accordance with some embodiments (not to scale). The e-cigarette has a generally cylindrical shape, extending along a longitudinal axis indicated by dashed line LA, and comprises two main components, namely a body 20 and a cartomizer 30. The cartomizer includes an internal chamber containing a reservoir of nicotine, a vaporizer (such as a heater), and a mouthpiece 35. The reservoir may be a foam matrix or any other structure for retaining the nicotine until such time that it is required to be delivered to the vaporizer. The cartomizer 30 also includes a heater for vaporizing the nicotine and may further include a wick or similar facility to transport a small amount of nicotine from the reservoir to a heating location on or adjacent the heater.

The body 20 includes a re-chargeable cell or battery to provide power to the e-cigarette 10 and a circuit board for generally controlling the e-cigarette. When the heater receives power from the battery, as controlled by the circuit board, the heater vaporises the nicotine and this vapor is then inhaled by a user through the mouthpiece.

The body 20 and cartomizer 30 are detachable from one another by separating along the longitudinal axis LA, as shown in FIG. 1, but are joined together when the device 10 is in use by a connection, indicated schematically in FIG. 1 as 25A and 25B, to provide mechanical and electrical connectivity between the body 20 and the cartomizer 30. The electrical connector on the body 20 that is used to connect to the cartomizer also serves as a socket for connecting a charging device (not shown) when the body is detached from the cartomizer 30. The other end of the charging device can be plugged into a USB socket to re-charge the cell in the body of the e-cigarette. In other implementations, a cable may be provided for direct connection between the electrical connector on the body and a USB socket.

The e-cigarette 10 is provided with one or more holes (not shown in FIG. 1) for air inlet. These holes connect to an air passage through the e-cigarette 10 to the mouthpiece 35. When a user inhales through the mouthpiece 35, air is drawn into this air passage through the one or more air inlet holes, which are suitably located on the outside of the e-cigarette. This airflow (or the resulting change in pressure) is detected by a pressure sensor that in turn activates the heater to vaporize the nicotine from the cartridge. The airflow passes through, and combines with, the nicotine vapor, and this combination of airflow and nicotine vapor then passes out of the mouthpiece 35 to be inhaled by a user. The cartomizer 30 may be detached from the body 20 and disposed of when the supply of nicotine is exhausted (and replaced with another cartomizer if so desired).

It will be appreciated that the e-cigarette 10 shown in FIG. 1 is presented by way of example, and various other implementations can be adopted. For example, in some embodiments, the cartomizer 30 is provided as two separable components, namely a cartridge comprising the nicotine reservoir and mouthpiece (which can be replaced when the nicotine from the reservoir is exhausted), and a vaporizer comprising a heater (which is generally retained). As another example, the charging facility may connect to an additional or alternative power source, such as a car cigarette lighter.

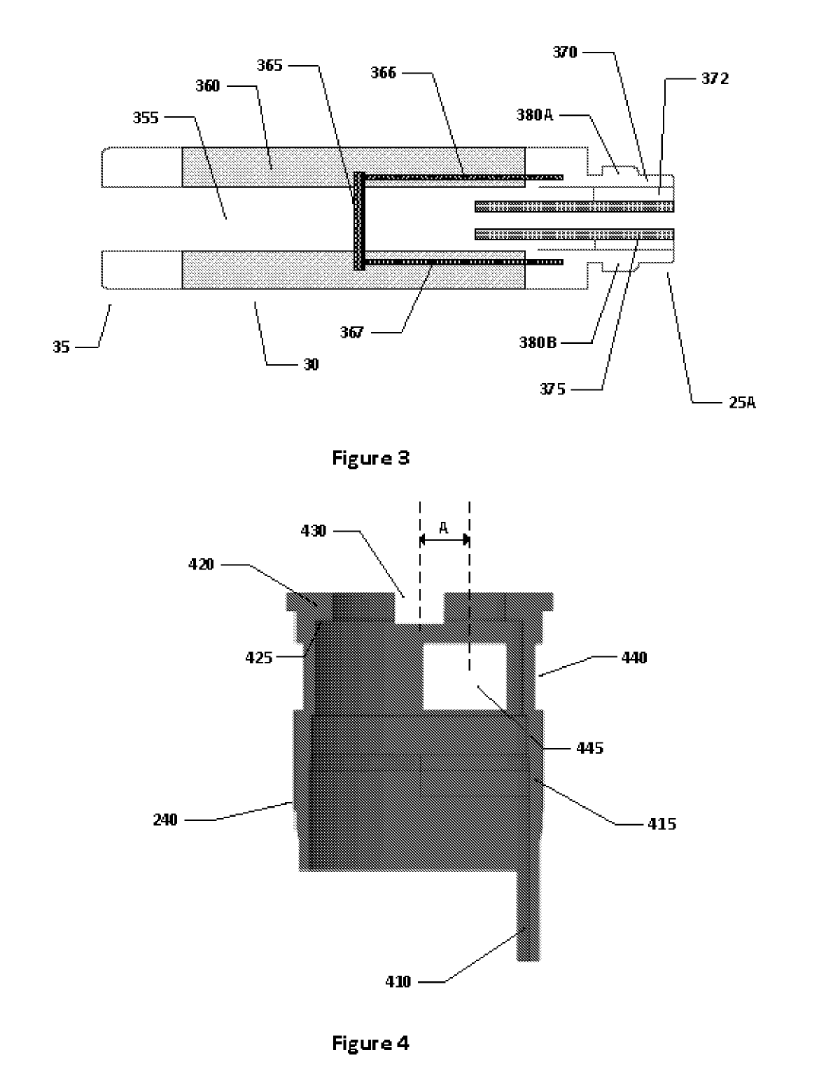

FIG. 2 is a schematic (simplified) diagram of the body 20 of the e-cigarette 10 of FIG. 1 in accordance with some embodiments. FIG. 2 can generally be regarded as a cross-section in a plane through the longitudinal axis LA of the e-cigarette. Note that various components and details of the body, e.g. such as wiring and more complex shaping, have been omitted from FIG. 2 for reasons of clarity.

As shown in FIG. 2, the body 20 includes a battery or cell 210 for powering the e-cigarette 10, as well as a chip, such as an application specific integrated circuit (ASIC) for controlling the e-cigarette 10. For example, the ASIC may include a sensor (or utilize a separate sensor, not shown in FIG. 2) to detect an inhalation on mouthpiece 35, and to provide power from the battery 210 to a heater in the cartomizer (see below) to vaporize nicotine into the airflow which is inhaled by a user. The body 20 further includes a cap 225 to seal and protect the far (distal) end of the e-cigarette 10.

At the opposite end of the body 20 from the cap 225 is the connector 25B for joining the body 20 to the cartomizer 30. In particular, the connector 25B provides mechanical and electrical connectivity between the body 20 and the cartomizer 30. The connector 25B includes a body connector 240, which is metallic (silver-plated in some embodiments) to serve as one terminal for electrical connection (positive or negative) to the cartomizer 30. The connector 25B further includes an electrical contact 250 to provide a second terminal for electrical connection to the cartomizer 30 of opposite polarity to the first terminal, namely body connector 240). The electrical contact 250 is mounted on a coil spring 255. When the body 20 is attached to the cartomizer 30, the connector 25A on the cartomizer pushes against the electrical contact 250 in such a manner as to compress the coil spring 255 in an axial direction, i.e. in a direction parallel to (co-aligned with) the longitudinal axis LA. In view of the resilient nature of the spring 255, this compression biases the spring 255 to expand, which has the effect of pushing the electrical contact 250 firmly against connector 25A, thereby helping to ensure good electrical connectivity between the body 20 and the cartomizer 30. The body connector 240 and the electrical contact 250 are separated by a trestle 260, which is made of a non-conductor (such as plastic) to provide good insulation between the two electrical terminals. The trestle 260 is shaped as described below to assist with the mutual mechanical engagement of connectors 25A and 25B.

FIG. 3 is a schematic diagram of the cartomizer 30 of the e-cigarette of FIG. 1 in accordance with some embodiments. FIG. 3 can generally be regarded as a cross-section in a plane through the longitudinal axis LA of the e-cigarette 10. Note that various components and details of the body 20, e.g. such as wiring and more complex shaping, have been omitted from FIG. 3 for reasons of clarity.

The cartomizer 30 includes an air passage 355 extending along the central (longitudinal) axis of the cartomizer 30 from the mouthpiece 35 to the connector 25A for joining the cartomizer 30 to the body 20. A reservoir of nicotine 360 is provided around the air passage 335. This reservoir 360 may be implemented, for example, by providing cotton or foam soaked in nicotine. The cartomizer 30 also includes a heater 365 for heating nicotine from reservoir 360 to generate nicotine vapor to flow through air passage 355 and out through mouthpiece 35 in response to a user inhaling on the e-cigarette 10. The heater 365 is powered through lines 366 and 367, which are in turn connected to opposing polarities (positive and negative, or vice versa) of the battery 210 via connector 25A (the details of the wiring between the power lines 366 and 367 and connector 25A are omitted from FIG. 3).

The connector 25A includes an inner electrode 375, which may be silver-plated or made of some other suitable metal. When the cartomizer 30 is connected to the body 20, the inner electrode 375 contacts the electrical contact 250 of the body 20 to provide a first electrical path between the cartomizer 30 and the body. In particular, as the connectors 25A and 25B are engaged, the inner electrode 375 pushes against the electrical contact 250 so as to compress the coil spring 255, thereby helping to ensure good electrical contact between the inner electrode 375 and the electrical contact 250.

The inner electrode 375 is surrounded by an insulating ring 372, which may be made of plastic, rubber, silicone, or any other suitable material. The insulating ring 372 is surrounded by the cartomizer connector 370, which may be silver-plated or made of some other suitable metal or conducting material. When the cartomizer 30 is connected to the body 20, the cartomizer connector 370 contacts the body connector 240 of the body 20 to provide a second electrical path between the cartomizer 30 and the body. In other words, the inner electrode 375 and the body connector 240 serve as positive and negative terminals (or vice versa) for supplying power from the battery 210 in the body 20 to the heater 365 in the cartomizer 30 via supply lines 366 and 367 as appropriate.

The cartomizer connector 270 is provided with two lugs or tabs 380A, 380B, which extended in opposite directions away from the longitudinal axis of the e-cigarette 10. These tabs 380A, 380B are used to provide a bayonet fitting in conjunction with the body connector 240 for connecting the cartomizer 30 to the body 20. This bayonet fitting provides a secure and robust connection between the cartomizer 30 and the body 20, so that the cartomizer 30 and body 20 are held in a fixed position relative to one another, without wobble or flexing, and the likelihood of any accidental disconnection is very small. At the same time, the bayonet fitting provides simple and rapid connection and disconnection by an insertion followed by a rotation for connection, and a rotation (in the reverse direction) followed by withdrawal for disconnection.

FIG. 4 is a schematic diagram of the body connector 240 of the e-cigarette 10 of FIG. 1 in accordance with some embodiments. The body connector 240 includes a wall 415 which has the general shape of a hollow cylinder (i.e. a tube or sleeve) which is co-aligned with respect to the longitudinal axis of the e-cigarette 10. Protruding from the wall 415 at one end of the tube is an arm 410 which is used for inserting and fixing the body connector 240 into the body 20. At the opposite end of the tube, the wall 415 is provided with a lip or rim 420 that is inwardly directed (towards the central longitudinal axis). This inwardly-directed lip 420 defines an aperture into hollow central portion of the body connector 240, and also creates an overhang 425 with respect to the main portion of the wall 415. In addition, the outside of the wall 415 (with respect to the central longitudinal axis) is provided with a shallow groove 440 that generally extends around the tube.

The path of the shallow groove 440 around the body connector 240 is interrupted by two windows or openings that extend through the wall 415 of the tube. One of these windows 445 is visible in FIG. 4; the other window is substantially opposite to window 445 (with respect to the longitudinal axis of the e-cigarette 10). The path of the inwardly directed lip 420 is likewise interrupted by two openings that extend through the wall 415 of the tube. One of these openings 430 is visible in FIG. 4; the other opening is substantially opposite to opening 430 (with respect to the longitudinal axis of the e-cigarette 10). If we take a center-line through window 445 and a center-line through opening 430 (each centre-line being parallel to the longitudinal axis of the e-cigarette 10), there is an offset between these two center-lines. This offset is denoted as “A” in FIG. 4, and corresponds to a given azimuthal rotation around the longitudinal axis of the e-cigarette 10.

When the cartomizer 30 is to be connected with body 20, they are held in coaxial alignment with one another, with connector 25A opposite to connector 25B. The connector 25A, which is the male portion of the bayonet fitting, is then inserted into connector 25B, the female portion of the bayonet fitting. More particularly, the end of the cartomizer connector 370 is inserted into the central hole of body connector 240, i.e. within wall 415, through the circular aperture defined by lip 420.

After an initial insertion, the lugs 380A, 380B extending radially outwards from the cartomizer connector 370 contact the end of the body connector 240, more particularly, lip 420. This contact prevents further insertion of the cartomizer connector 370 into the body connector 240 until (or unless) the cartomizer 30 and the body 20 are aligned in an azimuthal direction (by relative rotation about the longitudinal axis of the e-cigarette) so that the two lugs 380A, 380B coincide with respective openings 430 in the lip 420. The openings 430 allow the lugs 380A, 380B to pass through the lip 420, thereby enabling further insertion of the cartomizer connector 370 into the body connector 240.

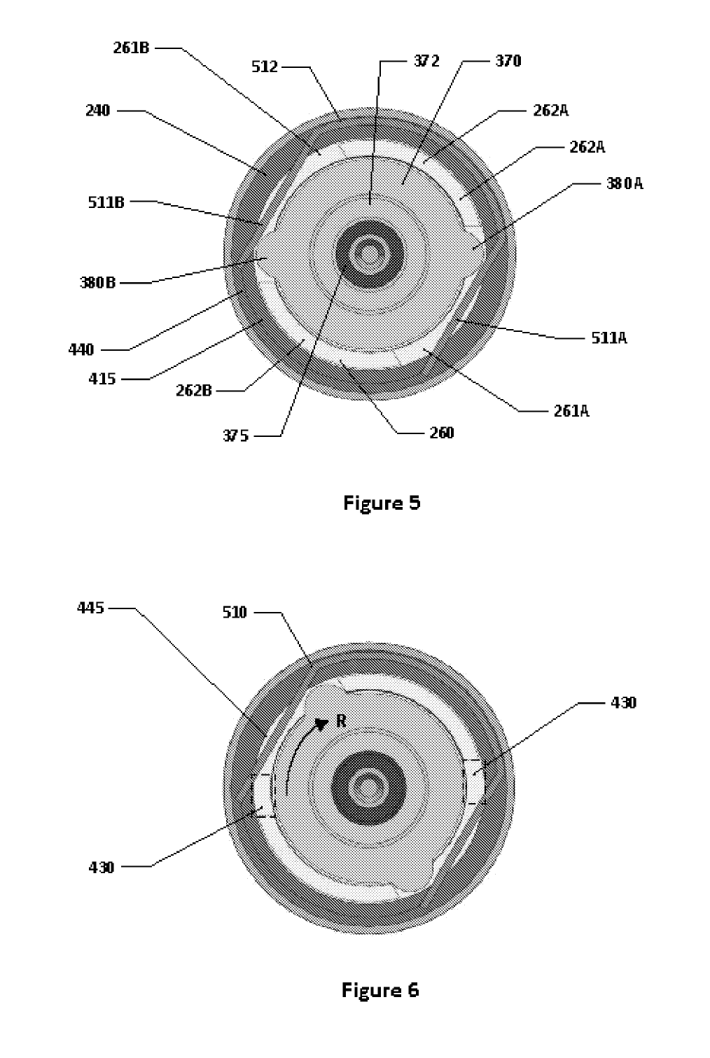

FIGS. 5 and 6 are cross-sections through the e-cigarette of FIG. 1 in a plane perpendicular to the longitudinal axis of the e-cigarette 10 in a direction looking into the body 20, in accordance with some embodiments. The cross-sections are taken through the connectors 25A, 25B after they are engaged by one another by inserting the cartomizer 30 into the body 20 (allowing for any rotation necessary to align the lugs 380A, 380B with respective openings 430 in the lip 420).

As can be seen from the cross-section of FIG. 5, once the lugs 380A, 380B have passed through the openings 430 in the lip 420 of body connector 440, the inner diameter of the body connector wall 415 is sufficiently large to allow rotation of the lugs 380A and 380B with respect to the longitudinal axis of the e-cigarette 10, as well as motion further along the longitudinal axis—i.e. in a direction to further insert the connector 25A of the cartomizer 30 into the connector 25B of the body 20. This further insertion however is limited by the trestle 260. The portion of the trestle 260 shown in FIG. 5 has the general shape of a hollow cylinder (i.e. a tube or sleeve) with respect to the longitudinal axis of the e-cigarette 10, and sits or nests immediately inside the body connector 240. The top of the trestle 260, i.e. the end closest to the cartomizer 30 after engagement, sits immediately below the rim 420 of the body connector 240, in other words, abutting the underside face 425 of the rim 420.

It will be appreciated that this positioning of the trestle 260 would prevent insertion of the lugs 380A, 380B past the lip 420 of body connector 440, except that in two opposing regions 261A, 261B the topmost portion of the trestle 260 is removed to a predetermined depth. Accordingly, only the two remaining (intervening) topmost portions 262A and 262B of the trestle 260 abut against the underside face 425 of the rim 420. The cutaway regions 261A, 261B have a depth corresponding to the size of the lugs 380A, 380B. In addition, the trestle 260 and the body connector 240 are mutually aligned in an azimuthal direction such that one end of each cutaway is below (aligned with) a respective opening 430 of the lip 420. The locations of these openings 430 in the lip 420 relative to the cutaway regions 261A, 261B are indicated schematically by the dashed line in FIG. 6.

In operation therefore, further insertion of lugs 380A, 380B through the openings 430 of the lip 420 of body connector 240 is permitted by respective cutaway regions 261A and 261B until the lugs 380A and 380B contact the top of the trestle 260 within these cutaway regions 261A, 261B. At this point the position has been reached as shown in FIG. 5, which will be referred to as a first point of engagement between the body 20 and the cartomizer 30. At this first point of engagement, the trestle 260 prevents any further (longitudinal) insertion of the body 20 into cartomizer 30. However, the cutaway regions 261A, 261B do define a channel between the top of the trestle 260 and the underside face 425 of the rim 420 of the body connector 240 to allow relative rotation of the connectors 25A and 25B. In particular, the connector 25A and/or the connector 25B can be rotated to move the lugs 380A, 380B along this channel, in the direction indicated by arrow R in FIG. 6, until the lugs 380A, 380B reach the end of respective the cutaway regions 261A, 261B and abut against retained wall regions 262A, 262B respectively. At this point the position has been reached as shown in FIG. 6, which will be referred to as a second or final point of engagement between the body 20 and the cartomizer 30. Note that in this second point of engagement, the lugs 380A, 380B are unable to move along the longitudinal axis, since they are constrained in one direction by the overhang 425 of the rim 420, and in the opposite direction by the floor of the cutaway regions 261A, 261B of the trestle 260. In addition, the lugs 380A, 380B are prevented from further rotation (past the second point of engagement is a direction away from the first point of engagement) by the retained wall portions 262A, 262B.

In fact, the lugs 380A, 380B are slightly biased against the overhang 425 of the rim 420 by the coil spring 255, since this tends to push the connector 25A (including lugs 380A, 380B) away from the body 20. This bias is resisted by the rim 420 of the body connector 240. Accordingly, the connectors 25A, 25B provide a bayonet fitting to retain the cartomizer 30 in engagement with the body 20.

The connector 25B includes a further component, namely U-spring 510. This U-spring comprises two arms 511A and 511B, which are substantially straight, and which are joined by an arc section 512. The U-spring 510 is resilient in that the arms can be separated by using an appropriate force, but are then mechanically biased to return to their original position by the elasticity of the arc section trying to regain its original curvature.

The U-spring 510 is positioned on the outside of the body connector 240. In particular, the U-spring 510 is retained in a longitudinal direction by groove 440 in the outer wall of the body connector 240. The U-spring 510 is positioned in an azimuthal direction by the location of windows 445, since the straight arms 511A, 511B are accommodated by (sit across) these windows 445, as shown in FIGS. 5 and 6.

It will be appreciated that as the connectors 25A and 25B are rotated from the first engagement position of FIG. 5 to the second engagement position of FIG. 6, the lugs 380A, 380B have, in effect, to push past the respective straight arms 511A, 511B. Accordingly, the straight arms 511A, 511B must be deflected or distorted outwards to allow movement of the lugs 380A, 380B from the first to second engagement positions, or vice versa, which in turn requires a force (moment or torque) to overcome the resilience of the U-spring 510.

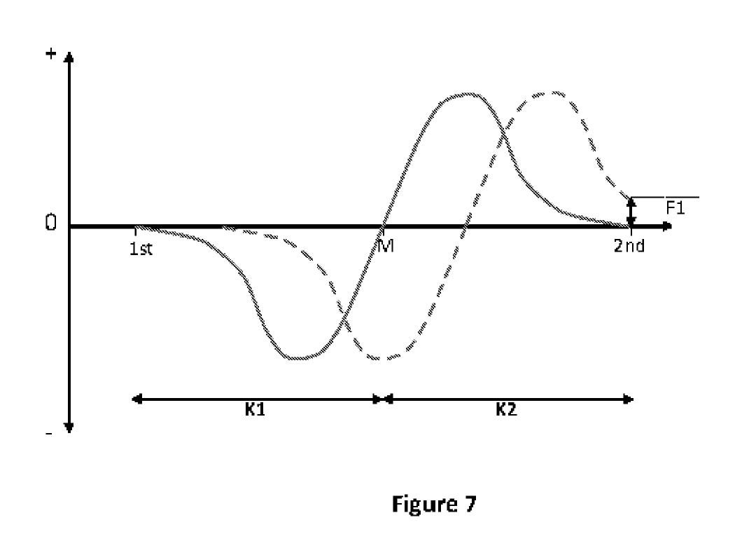

FIG. 7 is a schematic diagram illustrating the rotational force or bias (solid line) that the lugs 380A, 380B experience from the U-spring 510 as the connectors 25A and 25B are rotated from the first engagement position to the second engagement position or vice versa. In FIG. 7, a positive force is directed in the clockwise direction of FIGS. 5 and 6, i.e. from the first engagement position to the second engagement position, as indicated by arrow R in FIG. 6, while a negative force is directed in the opposite direction, i.e. from the second engagement position back to the first engagement position.

As shown in FIG. 7, as the connectors 25A and 25B are rotated from the first engagement position to the second engagement position, the lugs 380A, 380B initially experience a negative force, i.e. resisting the rotation from the first engagement position to the second engagement position. This region of negative force is denoted K1 in FIG. 7. However, once a transition point M has been reached, which is when the motion of the lugs 380A, 380B is substantially tangential to the respective arms 511A, 511B of the U-spring 510, the sign of the rotational force changes to become positive. For the region K2 beyond the transition point M, the U-spring 510 therefore contributes to urging the connectors 25A and 25B into the second engagement position.

When removing (disengaging) the body 20 from the cartomizer 30, the opposite rotation of the connectors 25A and 25B must occur, namely from the second engagement position to the first engagement position. This then aligns the lugs 380A, 380B with the openings 430 in the body connector 240, thereby permitting the cartomizer connector 440 to be withdrawn from the body connector 240. Note that in rotating from the second engagement position to the first engagement position, the connector 25A must first pass through region K2 in which the U-spring 510 provides a positive force—i.e. in a direction to resist motion from the second engagement position to the first engagement position. This resistance therefore provides a form of locking for the bayonet connection, since the U-spring 510 helps to prevent accidental disengagement of the cartomizer 30 from the body 20. In particular, such disengagement in the e-cigarette 10 can only occur if a sufficient rotational force is applied to overcome this initial resistance of the U-spring 510. Once this resistance has been overcome, and the rotation has reached the transition point M, the sign of the force from the U-spring 510 changes, and it urges the connectors 25A, 25B to rotate in the direction back to the first engagement position. In this position, the lugs 380A, 380B are aligned with the openings 430 in the body connector 440, thereby permitting withdrawal of the cartomizer 30 from the body 20.

FIG. 7 also illustrates the rotational force (dashed line) in an alternative arrangement in which the U-spring 510 is slightly rotated compared with the position shown in FIGS. 5 and 6 (in a clockwise direction). This rotation can be accomplished by moving the windows 445 relative to the openings 430 and the position of the trestle 260 (which both remain as shown in FIGS. 5 and 6). In other words, the alternative arrangement has a different value of the offset angle A shown in FIG. 4 between the windows 445 and the openings 430.

This slight change in location of the U-spring 510 induces in effect a corresponding sideways translation of the force curve relative to the first and second engagement positions (which can be considered as defined by the cutaway portions 261A, 261B of the trestle). In particular, the dashed line force curve generally follows the solid line curve discussed above, but shifted to the right (in the rotational direction from the first engagement position to the second engagement position). This shift results in the U-spring 510 continuing to exert a positive rotational force (indicated as F1 in FIG. 7) on the lugs 380A, 380B when the connectors 25A, 25B are in the second engagement position. This residual force in the positive azimuthal (rotational) direction acts to hold the lugs 380A, 380B against the sides of the respective remaining wall portions 262A, 262B which prevent further rotation of the lugs 380A, 380B in the direction of arrow R (see FIG. 6).

Compared with the force curve shown in solid line, the force curve shown in the dashed line of FIG. 7 helps to prevent any slight relative wobble of the body 20 and cartomizer 30 in an azimuthal direction, in particular away from the second engagement position towards the first engagement position (i.e. in the opposite direction to arrow R), since the U-spring 510 in effect biases the cartomizer connector 370 into the second engagement position. Accordingly, setting the offset angle A of FIG. 4 to position the U-spring 510 so that it provides the dashed force line of FIG. 7 helps to achieve a more secure and robust mechanical and electrical connection for e-cigarette 10.

Note that as the connectors 25A and 25B are rotated from the first engagement position to the second engagement position, energy is saved into the U-spring in region K1 and then released in region K2. In other words, having a user rotate the connectors 25A, 25B in region K1 against the opposing force of the U-spring 510 provides the energy to place the U-spring 510 into a biased configuration, which is then used to hold cartomizer connector 370 in the second engagement position. It will also be noted that the mechanical biasing force provided by the U-spring 150 is primarily in a radial direction (towards the longitudinal axis). However, if the points of contact between the lugs 380A, 380B and the corresponding arms 511A, 511B are in positions where the arms 511A, 511B are not completely tangential (perpendicular) to the radial direction, which may arise in part because of an outward deflection of arms 511A, 511B by lugs 380A, 380B, then a component of this radial force is converted into a rotation force, which can be used as described above to retain the connectors 25A, 25B in their final engagement position.

In addition, note that FIG. 7 does not incorporate any friction arising from motion of the lugs 380A, 380B against the surface of the spring 510. However, a component of the biasing force from the U-spring 510 is normal to the point of contact between the lugs 380A, 380B and the respective arms 511A, 511B of the U-spring 510. This biasing force, in a substantially radial or normal direction, may cause increased friction between the lugs 380A, 380B and the respective arms 511A, 511B of the spring 510, and this increased friction may also help to prevent wobble of the cartomizer connector 370 when located in the second engagement position.

Although the embodiments discussed above illustrate the use of U-spring 510 to provide a bias for the bayonet fitting, it will be appreciated that many other mechanisms or approaches are available for performing such a function. For example, rather than utilizing the curved segment 512 of the U-spring 510 to provide an elastic or biasing force, each window 445 might be individually fitted with a biasing member, analogous to the two U-spring arms 511, but omitting curved segment 512 so that the biasing members are not joined together. The biasing members are then elastically deformed by the rotation of lugs 380A, 380B (or any other suitable form of actuating component)—for example, the biasing members could comprise a straight or curved strip of material (such as rubber) that is compressed by the rotation of lugs 380A, 380B, or a straight or curved strip of resilient material (such as metal or plastic) that is deflected outwards by the rotation of lugs 380A, 380B.

The configuration illustrated in the Figures above provides the biasing members on the outside (in a radial direction) of the lugs 380A, 380B. In other configurations however, the biasing member(s) may be provided on the inside (in a radial direction) of some suitable actuating component, or alternatively they may be offset from the actuating component in a longitudinal direction, such that the compression, deflection or other elastic distortion occurs primarily in a direction parallel to the longitudinal axis. Furthermore, the total number of biasing members may vary from one configuration to another (e.g. one, two, three, four or more biasing members may be present). Accordingly, the biasing member(s) and the corresponding actuating member(s) may have any suitable shape, position and configuration for providing an appropriate biasing force or torque.

In addition, the allocation of the different components of the bayonet fitting, including such biasing member(s) and the corresponding actuating member(s), to the different components of the electronic vapor provision systems may be different from that shown in the above embodiments. Note also that although the various components may be sold together as a complete electronic vapor provision system, in some cases the different components may be sold individually, for example, as replacement unit if the nicotine in a cartomizer is exhausted.

In order to address various issues and advance the art, this disclosure shows by way of illustration various embodiments in which that which is claimed may be practiced. The advantages and features of the disclosure are of a representative sample of embodiments only, and are not exhaustive and/or exclusive. They are presented only to assist in understanding and to teach that which claimed. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc other than those specifically described herein. The disclosure may include other inventions not presently claimed, but which may be claimed in future.

1. Apparatus comprising a first unit for connection by a bayonet fitting to a second unit in an electronic vapor provision system having a longitudinal axis, wherein the bayonet fitting provides a mechanical and electrical connection between the first and second units, the first unit being arranged to:
receive insertion of the second unit along said longitudinal axis to a first engagement position of the bayonet fitting; and
allow the second unit to rotate about the longitudinal axis from the first engagement position to a final engagement position that prevents both (i) relative movement of the first and second units along said longitudinal axis, and (ii) rotation of the second unit past the final engagement position further away from the first engagement position;
and wherein the first unit further includes in the bayonet fitting a biasing means that applies a rotational bias against rotation of the second unit from the final engagement position back to the first engagement position.

2. The apparatus of claim 1, wherein a transition point is located between the first engagement position and the final engagement position, and when the second unit is located between the first engagement position and the transition point, the bias means applies a rotational bias in favor of rotation of the second unit in a rotational direction from the final engagement position towards the first engagement position, and when the second unit is located between the final engagement position and the transition point, the bias means applies a rotational bias in favor of rotation of the second unit in a rotational direction from the first engagement position towards the final engagement position.

3. The apparatus of claim 2, wherein the bias means suffers elastic deformation as the second unit is rotated between the first engagement position and the final engagement position, and wherein the elastic deformation is a maximum at said transition point.

4. The apparatus of claim 3, wherein said elastic deformation is primarily in a radial direction with respect to the longitudinal axis.

5. The apparatus of claim 4, wherein said elastic deformation is caused by at least one protruding member on the second unit, and wherein said transition point occurs when the biasing means has a tangential configuration with respect to the rotation of said at least one protruding member.

6. The apparatus of claim 5, wherein said biasing means comprises a substantially U-shaped member a pair of opposing arms that joined together by an arc section, wherein said a rotational bias against rotation of the second unit from the final engagement position back to the first engagement position is caused by separation of the arms from a rest position.

7. The apparatus of claim 6, wherein the arc section is substantially coaxial with said longitudinal axis.

8. The apparatus of claim 7, wherein the arc section is rotationally located with respect to said first and final engagement positions such that said rotational bias is applied when the first and second units are in the final engagement position.

9. The apparatus of claim 8, wherein the first unit includes a connector which includes:
one or more channels for receiving a respective protruding member of the second unit; and
a pair of windows for receiving a respective opposing arm of said substantially U-shaped member, wherein the second unit has two protruding members that contact the bias means through a respective window.

10. The apparatus of claim 9, wherein the one or more channels for receiving a respective protruding member of the second unit act to guide the second unit as it is inserted into the first unit to the first engagement position and then rotated from the first engagement position to the final engagement position.

11. The apparatus of claim 1, wherein said rotational bias is applied when the first and second units are in the final engagement position.

12. The apparatus of claim 1, wherein said first unit comprises a body portion of an electronic vapor provision system, said body including a cell or battery and a control circuit.

13. An electronic vapor provision system comprising:
the apparatus of claim 12 as the body portion; and
a cartomizer as the second unit, wherein said cartomizer includes a reservoir of a substance and a heater powered by the cell or battery of said portion for vaporizing said substance.

14. An electronic vapor provision system comprising:
a first unit comprising a battery or cell;
a second unit comprising a heater and a nicotine source for producing nicotine vapor when heated;
wherein the first unit and the second unit comprise a bayonet fitting for providing a mechanical and electrical connection between the first and second unit, wherein said electrical connection allows the battery or cell to provide power to the heater to produce nicotine vapor from the nicotine source;
wherein the electronic vapor provision system has a longitudinal axis, and the bayonet fitting is configured such that the first and second units are connected by:
relative movement of the first and second units along said longitudinal axis to a first engagement position; and
relative rotation of the first and second units about the longitudinal axis from the first engagement position to a final engagement position that prevents both (i) relative movement of the first and second units along said longitudinal axis, and (ii) relative rotation of the first and second units further away from the first engagement position;
and wherein the bayonet fitting further includes a biasing means that provides a rotational bias to prevent rotation of the first and second units from the final engagement position to the first engagement position.

15. The system of claim 14, wherein a transition point is located between the first engagement position and the final engagement position, and when the first and second units are located between the first engagement position and the transition point, the bias means applies a rotational bias in favor of relative rotation of the first and second units in a rotational direction from the final engagement position towards the first engagement position, and when the first and second units are located between the final engagement position and the transition point, the bias means applies a rotational bias in favor of relative rotation of the first and second units in a rotational direction from the first engagement position towards the final engagement position.

16. The system of claim 15, wherein the bias means suffers elastic deformation as the first and second units are rotated between the first engagement position and the final engagement position, and wherein the elastic deformation is a maximum at said transition point.

17. The system of claim 16, wherein said elastic deformation is primarily in a radial direction with respect to the longitudinal axis.

18. The system of claim 17, wherein said elastic deformation is caused by at least one protruding member on the first or second unit, and wherein said transition point occurs when the biasing means has a tangential configuration with respect to the rotation of said at least one protruding member.

19. The system of claim 18, wherein said biasing means comprises a substantially U-shaped member a pair of opposing arms that joined together by an arc section, wherein said a rotational bias is caused by separation of the arms from a rest position.

20. The system of claim 19, wherein the arc section is substantially coaxial with said longitudinal axis.

21. The system of claim 20, wherein the arc section is rotationally located with respect to said first and final engagement positions such that said rotational bias is applied when the first and second units are in the final engagement position.

22. The system of claim 21, wherein the bayonet fitting includes a connector which includes:
one or more channels for receiving a respective protruding member of the first or second unit; and
a pair of windows for receiving a respective opposing arm of said substantially U-shaped member, wherein the first or second unit has two protruding members that contact the bias means through a respective window.

23. The system of claim 22, wherein the one or more channels for receiving a respective protruding member of the first or second unit act to guide the relative insertion into the first engagement position and then the relative rotation from the first engagement position to the final engagement position.

24. The system of claim 14, wherein said rotational bias is applied when the first and second units are in the final engagement position.

25. The system of claim 14, wherein the biasing means are located in the first unit.

26. An electronic vapor provision system comprising:
first and second parts which when connected define a longitudinal axis, wherein the first and second parts are mechanically and electrically connectable via a bayonet fitting, the bayonet fitting providing co-axial and radial mechanical bias relative to the longitudinal axis.

27. (canceled)

28. (canceled)
